(19) United States
(12) Patent Application Publication
(10) Pub. No.: US 2016/0089684 A1
(43) Pub. Date: Mar. 31, 2016

(54) Built-in Liquid Dispensing Device

(71) Applicant: Clydell Duncan, Beaumont, TX (US)

(72) Inventor: Clydell Duncan, Beaumont, TX (US)

(21) Appl. No.: 14/842,559

(22) Filed: Sep. 1, 2015

Related U.S. Application Data
(60) Provisional application No. 62/057,358, filed on Sep. 30, 2014.

(51) Int. Cl. B05B 11/00; B60R 15/02; B05B 15/06

(52) U.S. Cl. CPC B05B 11/3052; B05B 15/061; B60R 15/02

(57) ABSTRACT

A built-in liquid dispensing device for maintaining a germ-free environment within a vehicle. The built-in liquid dispensing device includes a compartment having an upper wall, a lower wall, one or more sidewalls, and an open front wall that provides access to the interior thereof. The open front wall is removably covered by a door that is pivotally secured to the upper wall. The device further includes a liquid dispenser that is disposed within a recessed area located on the lower wall of the compartment. The recessed area allows the liquid dispenser to remain in a stationary position while the vehicle is in motion. A plurality of fasteners are secured to the interior of the compartment in order to prevent the dispenser from falling out of the compartment. The built-in liquid dispensing device can be integrated into a vehicle's dashboard, center console, or rear seats.

### CROSS REFERENCE TO RELATED APPLICATION

This application claims the benefit of U.S. Provisional Application No. 62/057,358 filed on Sep. 30, 2014. The above identified patent application is herein incorporated by reference in its entirety to provide continuity of disclosure.

### BACKGROUND OF THE INVENTION

### Field of the Invention

The present invention relates to built-in liquid dispensing devices. More specifically, the present invention provides a built-in liquid dispensing device that comprises a compartment having a recessed area disposed on a lower wall in which a liquid dispenser rests. The compartment comprises a plurality of fasteners that extend from one or more sidewalls thereof in order to protect the liquid dispenser from becoming removed from the compartment. The device is adapted to be integrated into a vehicle's dashboard, center console, or rear seats.

Conventional vehicles, boats, and the like, do not have running water and soap readily available to wash one's hands. As a result, germs can easily spread throughout a vehicle if an individual sneezes or coughs into their hand and subsequently touches a door handle, radio dial, or other vehicle hardware. A solution is to employ the use of hand sanitizer to clean one's hands. However, hand sanitizer is often forgotten at home or misplaced in various locations, such as between the seats of a vehicle. Therefore, there exists a need in the prior art for a liquid hand sanitizer dispenser that can be integrated within a vehicle in order to prevent the spread of germs.

Devices have been disclosed in the prior art that relate to built-in liquid dispensing devices. These include devices that have been patented and published in patent application publications. These devices generally relate to liquid dispensing systems for vehicles, such as U.S. Pat. No. 7,108,094 to Daniels, U.S. Patent Application Publication Number 2013/0262345 to Ciavarella et al., U.S. Pat. No. 8,602,257 to Godsell, U.S. Patent Application Publication Number 2013/0221027 to Woelbing et al., and U.S. Pat. No. 5,730,360 to Wang.

These prior art devices have several known drawbacks. The devices in the prior art fail to provide a self-contained compartment with a liquid dispenser disposed in a recessed area, wherein the compartment is adapted to be integrated into the dashboard of the vehicle. Some devices include a reservoir and pump system disposed in other areas of the vehicle, such as the trunk, wherein only the dispenser head is included in the dashboard of the vehicle, thereby requiring a user to access other parts of the vehicle in order to refill the dispenser. Other devices include a liquid or powder sanitizing system that is adapted to removably connect to the exterior of the dashboard or the center console, however, these devices are not integral to the vehicle and occupy additional space within the vehicle. Thus, the prior art devices fail to disclose a built-in liquid dispensing device that conveniently allows a user to sanitize his or her hands.

In light of the devices disclosed in the prior art, it is submitted that the present invention substantially diverges in design elements from the prior art and consequently it is clear that there is a need in the art for an improvement to existing built-in liquid dispensing devices. In this regard the instant invention substantially fulfills these needs.

### SUMMARY OF THE INVENTION

In view of the foregoing disadvantages inherent in the known types of built-in liquid dispensing devices now present in the prior art, the present invention provides a new built-in liquid dispensing device wherein the same can be utilized for providing convenience for the user when sanitizing one's hands while in a vehicle.

It is therefore an object of the present invention to provide a new and improved built-in liquid dispensing device that has all of the advantages of the prior art and none of the disadvantages.

It is another object of the present invention to provide a built-in liquid dispensing device comprising a compartment having an upper wall, a lower wall, one or more sidewalls, and an open front wall that provides access to the interior thereof, wherein the compartment is adapted to be integrated into a vehicle's dashboard, center console, or rear seats.

Another object of the present invention is to provide a built-in liquid dispensing device further comprising a liquid dispenser disposed on the lower wall of the compartment.

Yet another object of the present invention is to provide built-in liquid dispensing device wherein the liquid dispenser rests in a recessed area disposed on the lower wall adapted to allow the dispenser to remain in a stationary position while the vehicle is in motion.

Yet another object of the present invention is to provide built-in liquid dispensing device further comprising a door pivotally secured to the upper wall of the compartment and adapted to removably cover the open front wall thereof in order to provide access to the liquid dispenser.

Yet another object of the present invention is to provide built-in liquid dispensing device further comprising a plurality of fasteners secured to the open front wall of the compartment in order to protect the dispenser from becoming removed from the lower end of compartment.

Another object of the present invention is to provide a built-in liquid dispensing device that may be readily fabricated from materials that permit relative economy and are commensurate with durability.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of an embodiment of the built-in liquid dispensing device wherein the compartment is in an open configuration.

FIG. 2 shows a perspective view of the liquid dispenser of the built-in liquid dispensing device.

FIG. 3 shows a perspective view of an embodiment of the built-in liquid dispensing device wherein the compartment is integral to a dashboard of a vehicle.

### DETAILED DESCRIPTION OF THE INVENTION

Reference is made herein to the attached drawings. Like reference numerals are used throughout the drawings to depict like or similar elements of the built-in liquid dispensing device. For the purposes of presenting a brief and clear description of the present invention, the preferred embodiment will be discussed as used for dispensing liquid hand-sanitizer from the interior of a vehicle. The figures are intended for representative purposes only and should not be considered to be limiting in any respect.

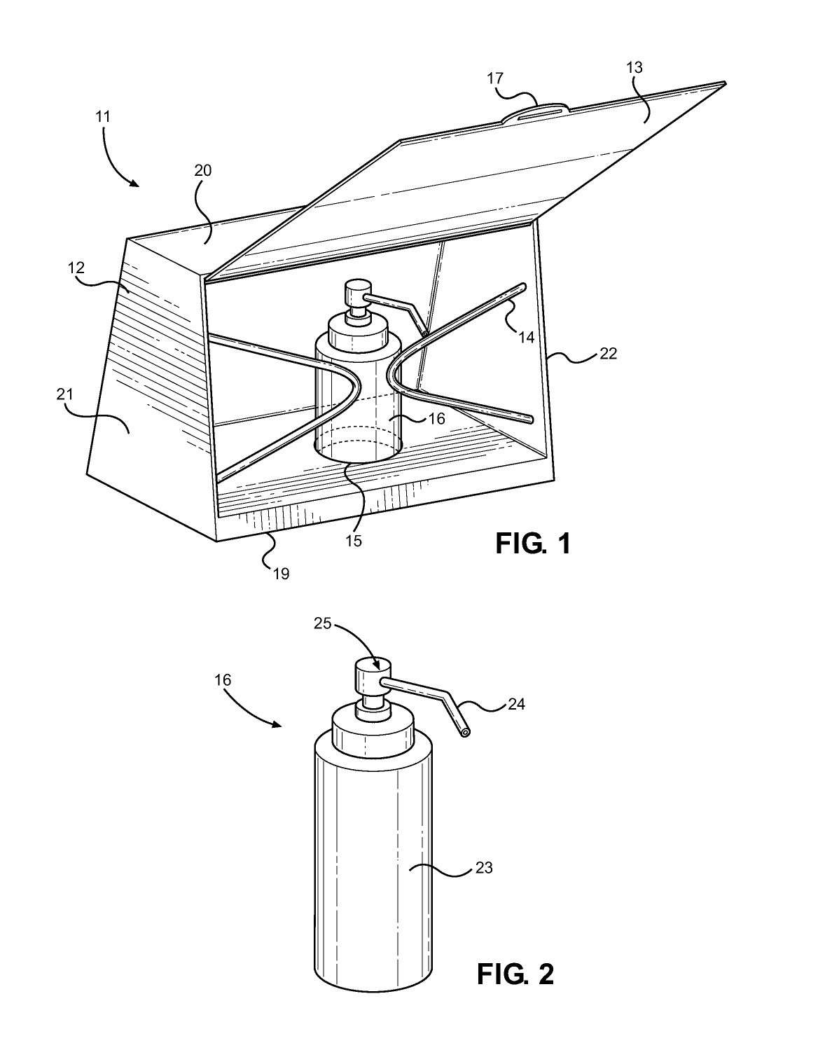

Referring now to FIG. 1, there is shown a perspective view of an embodiment of the built-in liquid dispensing device wherein the compartment is in an open configuration. The built-in liquid dispensing device 11 comprises a compartment 12 having a lower wall 19, an upper wall 20, one or more sidewalls 21, and an open front wall 22. The compartment 12 is adapted to receive a liquid dispenser 16 therein, as well as be integrated within the interior of a vehicle in such areas including the dashboard, the rear seats, or the console thereof. In the illustrated embodiment, the compartment 12 is substantially rectangular in configuration. However, in other embodiments, the compartment 12 can be any suitable configuration adapted to fit within the dashboard, rear seats, console, or the like.

The open front wall 22 is removably covered by a door 13, wherein the door 13 is pivotally secured to the upper wall 20 of the compartment 12. The door 13 is movable between an open configuration and a closed configuration. In an open configuration, the door 13 is lifted upwards so as to allow a user to access the liquid dispenser 16 therein. In a closed configuration the door 13 lies flush against the edges of the front wall 22. The dimension of the door 13 comprises substantially the same dimension as the open front wall 22 so as to allow the interior of the compartment 12 to remain hidden when the door 13 is in a closed orientation. A tab 17 is disposed on an edge of the door 13 that is not secured to the upper wall, thereby allowing the door 13 to be lifted. In some embodiments, the door 13 comprises a locking mechanism, such as a magnetic fastener, adapted to further maintain the door 13 in a closed configuration and thus ensuring that the liquid dispenser 16 does not become easily removed therefrom.

The interior of the compartment 12 is adapted to house a liquid dispenser 16. The lower wall 19 of the compartment 12 comprises a recessed area 15, wherein the liquid dispenser 16 rests. The recessed 15 area provides a ledge that prevents the liquid dispenser 16 from tipping over while the vehicle is in motion. In the illustrated embodiment, the recessed area 15 is circular and comprises the same diameter as the diameter of the lower end of the liquid dispenser 16. However, in other embodiments, the recessed area 15 can comprise any suitable shape as long as the liquid dispenser 16 is able to fit therein and is prevented from moving within the compartment 12 while the vehicle is in motion.

The built-in liquid dispensing device 11 further comprises a plurality of fasteners that further ensure the liquid dispenser 16 will not become removed from the compartment while the door 13 is in an open configuration. In the illustrated embodiment, the fasteners comprise a pair of V-shaped brackets 14 disposed on opposing sides of the lateral sidewalls 21. The brackets 14 are perpendicularly extended from the sidewalls 21, wherein the brackets 14 are facing one another. The brackets 14 are positioned between the open front wall 22 and the recessed area 15. The brackets 14 are fixed and rigid in order to prevent the liquid dispenser 16 from rolling out of the lower end compartment 12 if the dispenser 16 becomes dislodged from the recessed area 15. In other embodiments, the fastener can be any suitable configuration as long as the fastener creates an obstacle that prevents the removal of the liquid dispenser 16 via the lower end of the open front wall 22 of the compartment 12.

In alternate embodiments, The brackets 14 are pivotally secured to the sidewalls 21 of the compartment 12 in order to allow the liquid dispenser 16 to be removed from the compartment 12. The brackets 14 are secured by a spring hinge, wherein the spring has a tendency towards maintaining the brackets 14 in a closed configuration, such that the brackets are perpendicularly extended from the sidewalls 21. The liquid dispenser 16 can be removed from the compartment 12 via the front wall 22 so as to allow the liquid dispenser 16 to be replaced or refilled with sanitizing liquid.

Referring now to FIG. 2, there is shown a perspective view of the liquid dispenser of the built-in liquid dispensing device. The liquid dispenser 16 is adapted to store and dispense sanitizing liquid therefrom. The liquid dispenser 16 comprises a container 23 having a hollow interior volume in which liquid can be stored. The container 23 comprises an open upper end, wherein the open upper end receives a cap 25 having a nozzle 24 thereon. The cap 25 is operably connected to a pump connected to a tube, wherein the tube is disposed within the container 23. As the user presses downwards on the cap 25, the pump draws liquid from the tube and dispenses the liquid from the nozzle 25. In some embodiments, the liquid dispenser 16 comprises hand sanitizer therein, such as isopropyl alcohol.

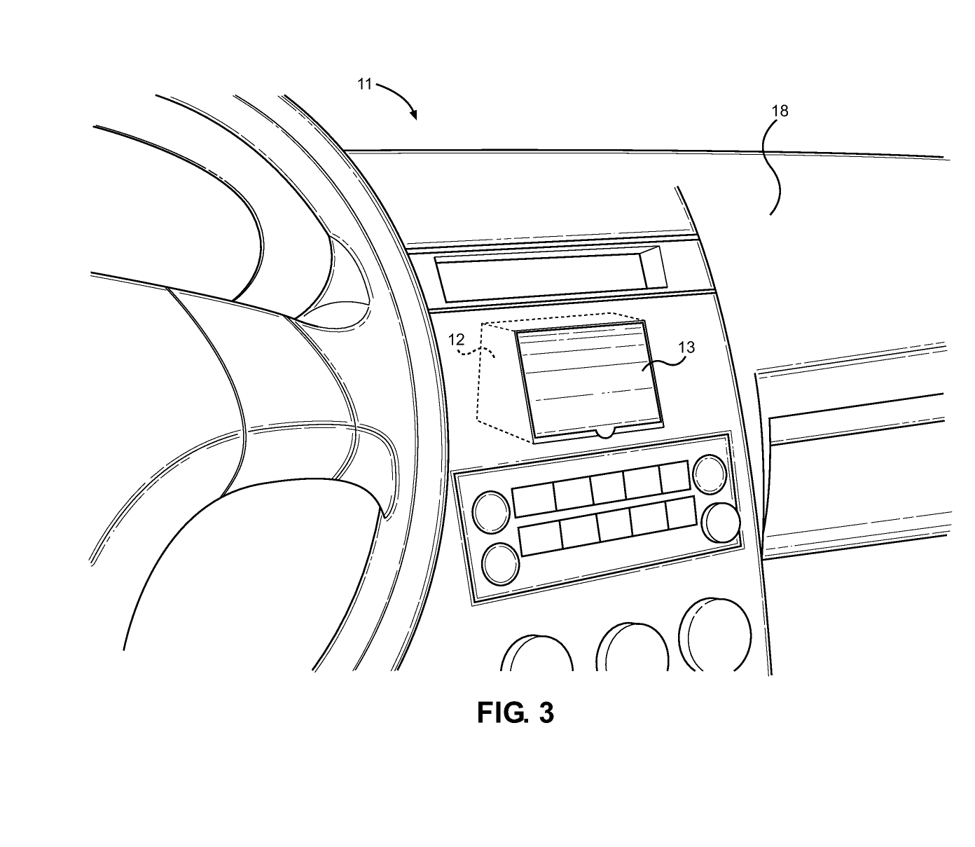

Referring now to FIG. 3, there is shown a perspective view of an embodiment of the built-in liquid dispensing device wherein the compartment is integral to a dashboard of a vehicle. The built-in liquid dispensing device is adapted to be disposed in the interior of a vehicle, wherein the sidewalls, the upper wall, and the lower wall of the compartment 12 are integral to the dashboard, console, or rear seat of the vehicle. In the illustrated embodiment, the compartment 12 is integral within the dashboard 18 of the vehicle. The open front wall is adapted to remain flush with the exterior surface of the dashboard 18. In other embodiments, the compartment 12 is mounted within the dashboard 18 or the like by any suitable fastener, including adhesive or screws. In operation, a user lifts the door 13 upwards, thereby revealing the liquid dispenser. The user can manually open and close the door 13 as needed in order to reveal the interior compartment therein. The user dispenses sanitizing liquid from the dispenser and closes the door 13. Thus, the vehicle remains germ-free as the user places his or her hands on the interior thereof due to the sanitizing liquid placed on the user's hands.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A built-in liquid dispensing device, comprising:
a compartment having an interior volume and an open front wall, wherein said compartment is adapted to be integrated into a vehicle;
a recessed area disposed on a lower wall of said compartment;
a liquid dispenser removably positioned within said recessed area, wherein said liquid dispenser is adapted to dispense a sanitizing liquid.

2) The built-in liquid dispensing device of claim 1, further comprising a plurality of fasteners secured to one or more sidewalls of said compartment and disposed between said recessed area and said open front wall of said compartment in order to prevent said liquid dispenser from becoming removed through said open front wall.

3) The built-in liquid dispensing device of claim 2, wherein said plurality of fasteners are a pair of V-shaped brackets, wherein a first V-shaped bracket is perpendicularly extended from said one or more sidewalls of said compartment and a second V-shaped bracket is perpendicularly extended from an opposing said one or more sidewalls of said compartment.

4) The built-in liquid dispensing device of claim 1, further comprising a door pivotally secured to an upper wall of said compartment and adapted to removably cover said open front wall.

5) The built-in liquid dispensing device of claim 1, wherein said liquid dispenser comprises sanitizing liquid therein.

6) The built-in liquid dispensing device of claim 1, wherein said liquid dispenser comprises a hand pump in order to dispense said sanitizing liquid therefrom.
